(19) United States
(12) Patent Application Publication
(10) Pub. No.: US 2014/0120213 A1
(43) Pub. Date: May 1, 2014

(54) FLAVOR INFUSED PASTRY FATS FOR PUFF PASTRY

(71) Applicant: Van MILLER, Norval (CA)

(72) Inventor: Van MILLER, Norval (CA)

(21) Appl. No.: 13/750,229

(22) Filed: Jan. 25, 2013

Related U.S. Application Data
(60) Provisional application No. 61/720,967, filed on Oct. 31, 2012.

(51) Int. Cl. A21D 2/16

(52) U.S. Cl. CPC A21D 2/165
USPC 426/19; 426/601; 426/603; 426/608; 426/502; 426/556

(57) ABSTRACT

A flavor infused pastry fat composition for the preparation of puff pastry baked products has a flavoring agent which is incorporated into the fat phase of the pastry fat during its preparation so as to become part of the fat phase of a puff pastry baked product, when baked. The flavor infused pastry fat has an SFI characteristic such that it is liquid at 36° C., is solid at 4° C., and has 26% to 40% solid fat component at 10° C. and 10% to 30% solid fat component at 25° C.

### FIELD OF THE INVENTION

This invention relates to the baking industry, and is particularly directed to that segment of the baking industry which is concerned with the preparation and baking of pastry products. More specifically, the present invention is directed to that segment of the baking industry which is concerned with the preparation and baking of puff pastry baked products. Still further, the present invention is directed toward the provision of flavor infused pastry fats which are used in the preparation of puff pastry baked products having specific flavors, without the necessity for the use of discrete flavored additives placed in or on the puff pastry product just prior to or immediately following the baking operation.

### BACKGROUND OF THE INVENTION

The commercial baking industry is a very significant portion of the prepared food industries, and in general may be considered to be the provider of bread products of all sorts, the provider of cakes and cookies of all sorts, and the provider of pastry products of all sorts. Indeed, the pastry segment of the baking industry can be considered to be the providers of five significantly different types of pastries, which may be used particularly in the dessert field but which may also be used in such fields as savory baked food products, meat pies, and the like.

One type of commonly provided pastry is identified as shortcrust pastry, which type of pastry is commonly used for the preparation of tarts, pies, quiche products, and the like. Typically, shortcrust pastry has no leavening agent so as not to puff up during baking, however self-raising flour may be used. Shortcrust pastries are generally prepared using vegetable shortening, which is a pastry fat that is typically solid at room temperature, and which generally results in a crumbly pastry or pie crust.

Phyllo dough (also known as filo dough) is typically associated with Greek or Baltic cuisine, and comprises paper-thin sheets of unleavened flour dough.

Choux pastry generally finds itself used for desserts, and is a light pastry dough which generally comprises only butter, water, flour, and eggs. Typical baked products made with choux pastry include profiteroles, éclairs, French crullers, and even Yorkshire Pudding. These products rely on the high moisture content of the dough to create steam during cooking so as to puff up the pastry, rather than the employment of any raising agent.

Flaky pastry is a light, flaky, unleavened pastry which may be considered to be similar to puff pastry in some respects. However, in the case of flaky pastry, large lumps of shortening are mixed into the dough which may then be rolled and folded in a manner similar to the preparation of puff pastry. In this case, however, the chunks of shortening keep the rolled particles of dough separate from each other so that when the dough is baked they become flakes.

Puff pastry, which is of particular interest to the present invention, is a light, flaky, leavened pastry which contains several layers of fat which are typically in a substantially solid state at about 20° C. During its preparation, a first sheet of dough is spread with pastry fat, and then the sheet of dough is repeatedly folded and rolled out so as to produce a number of uniform layers of dough. Of course, the pastry fat is found between layers of dough, and is also rolled into the dough.

During baking, water evaporates into steam from the water content of the pastry fat, if any, and from the gluten constituent of the dough. Typical puff pastry products include puff pastry shells, croissants, and Danish pastries.

It must be noted that the pastry fat which is used for the preparation of puff pastry must have a reasonably sharp SFI (Solid Fat Index) characteristic. Moreover, it is important that whatever pastry fat is used in the preparation of puff pastries, it must provide a pleasant mouth feel when consumed. Typical pastry fats that are used in the baking industry for the preparation of puff pastries can include butter and lard, as well as vegetable shortenings which are typically prepared from hydrogenated vegetable oils.

No matter what, a typical puff pastry fat must be able to form a film around the gluten protein in the dough so as to stop it from developing and toughening the dough, but at the same time it must be able to trap gas so as to improve rising and flakiness of the puff pastry when baked. Because the pastry fat is rolled in, it must have an acceptable plasticity, as is well known to those skilled in the art, so as to perform well in puff pastries, croissants, and the like, where the dough and the fat are repeatedly folded into layers and rolled. Of course, the pastry fat must not be so hard that it will tear the dough; neither must it be so soft that it will simply soak into the layers of dough.

However, it is important that a distinction must be made between rolled in fat and fat which is simply added to the dough per se. A roll-in fat is typically butter or margarine or vegetable shortening, as noted above, and may be present in the baked puff pastry product in an amount as much as 50% of the flour weight. Butter is sometimes preferred for its taste, but limitations with respect to its processing temperature range (SFI characteristic) and particularly its cost militate against its widespread use. In the preparation of puff pastry baked products, in particular, fat is layered between sheets of dough which are manipulated by repeatedly folding and rolling the dough. Very often, in the preparation of puff pastry products such as Danish pastries, puff pastries per se, and croissants, there is a retarding step which is included between sequential folding and rolling operations, or after a predetermined number of folding and rolling operations, where the folded and rolled dough is permitted to rest—often at a reduced temperature—for a period of time.

Obviously, the purpose of the rolling steps is to preserve the structure of alternate layers of dough and fat, but some factors must be taken into consideration including the SFI characteristic and the plasticity of the pastry fat. Even the number of folds that will be given to the dough before it is subjected to a retarding step must be considered, as well as the temperature at which the retarding step will be taken. Of course, as is well known to those in the puff pastry baking industry, the specific details of any of these and other related factors are dependent upon other factors such as the type of pastry fat being used, the type of dough being used, the ambient temperature, the type of product being prepared, and so on.

In that regard, however, the plasticity of the pastry fat and its consistency should match that of the dough within the ambient temperature range where the folded and rolled dough/pastry fat product is being worked, and including the temperature of the proofer or other place where the retarding step will be carried out. As noted, if the pastry fat is too soft—that is, softer than the dough at room temperature—then as the dough mass warms up during rolling and folding, the pastry fat will soak into the dough and the adjacent folded layers will knit together. Thus, the layering effect will be lost.

Puff pastries depend upon steam generation in the oven for their leavening. There is usually a water constituent in the puff pastry fat, in the range of perhaps 15% to 25% by weight. That water will be trapped and held in the fat layers of the dough, and while in the oven during baking it evaporates and expands so as to give the expanded, puffy, structure to the baked puff pastry product. However, it should also be noted that Danish pastries are further leavened by the addition of a small amount of yeast as one of the major constituents of the dough mixture as it is being prepared.

It is interesting to note that the celebrated chef Julia Child recommended that in the preparation of many puff pastry products, there should be at least 73 layers, and up to 730 layers.

Many baked puff pastry products are provided to the market having specific flavors such as chocolate, raspberry, lemon, coffee, and so on. In particular, there are many baked puff pastry products such as croissants and Danish pastries that are flavored; and in each case, the flavor which is provided for the baked puff pastry product comes as a consequence of the addition of a discrete flavoring additive to the product just prior to and/or immediately following the baking operation.

For example, many people like to eat chocolate flavored croissants. They are produced by placing chocolate syrup or a chunk of chocolate onto the folded and rolled dough/pastry fat sheet just prior to the final folding and shaping operation. Alternatively, chocolate flavor may be provided for croissants by coating the baked croissants with chocolate syrup or a chocolate flavored icing. In some instances, both steps are taken.

Likewise, a dollop of fruit jam such as raspberry, strawberry, blueberry, etc., or a dollop of flavored pie fillings such as lemon pie filling or the like, may be placed on the folded and rolled dough/pastry fat sheet just prior to the final folding and shaping operation. Danish pastries having various flavors are provided in much the same way, where the flavoring additive is placed on the folded and rolled puff pastry dough just prior to the final shaping and folding operations, before the baking operation.

The production of such croissants and Danish pastries, in particular, is expensive and time-consuming because it requires an additional step or steps; usually steps that are performed using manual labor. Thus, it is possible in some instances that such flavored croissants and Danish pastries, and the like, may come to the market at a higher selling price than ordinary croissants.

The inventor herein has quite unexpectedly discovered that it is possible to bring flavored croissants, in particular, to the market for about the same cost and at about the same selling price as ordinary croissants.

Indeed, the present invention as discussed hereafter applies to any flavored puff pastry product that may be brought to market, where the flavoring for the baked puff pastry product is incorporated into the pastry fat which is rolled into the dough, and not as an extra, discrete, flavoring additive to the folded and rolled and/or baked puff pastry product.

In other words, the flavoring component for a flavored baked puff pastry product is, in keeping with the present invention, an integral constituent of the rolled and folded baked puff pastry product, ab initio.

Thus, it is also possible as will be discussed hereafter, to bring to the market baked puff pastry products that have discrete flavors such as cheese, cinnamon, onion, sour cream, and so on; provided that in keeping with the present invention, the flavoring additive is included in and forms part of the pastry fat which will be used in the preparation of the baked puff pastry products.

This is accomplished by providing a flavor infused pastry fat composition which will be employed in the ordinary manner as is well-known to those skilled in the puff pastry art, and which is incorporated into the dough/pastry fat rolled and folded product in the usual manner, and without any additional steps or the requirement for specialized equipment.

### Discussion of the Prior Art

An interesting discussion of pastry shortening, particularly as it was used in earlier years, is given in Kriz et al. U.S. Pat. No. 3,985,911, issued Oct. 12, 1976. What is particularly taught is a shortening composition for the preparation of roll-in pastry dough which may be used in the range of 50° F. to 90° F. (10° C. to 32.2° C.), and which may be hydrous or anhydrous. The pastry shortening is prepared from vegetable fat and mixtures of vegetable fat and animal fat.

Biernoth et al. teach the fractionation of butterfat using a liquefied gas or a gas in the supercritical state, in U.S. Pat. No. 4,504,503 which issued Mar. 12, 1985. However, they note that a specific fraction containing a mixture of triglycerides having carbon numbers ranging from 24 to 42 will impart water-like properties to margarines and spreads; and that that residual fraction which predominantly comprises three long chain fatty acids can be used in fat blends which are intended for preparation of puff pastries.

Degli Angeli et al. U.S. Pat. No. 5,780,084, issued Jul. 14, 1998, is concerned particularly with a process for making layered and puffed pastry products. Here, however, the raw material for the dough does not contain a wheat flour; but may instead be made from such vegetable products as potato flakes or granules, precooked maize, tapioca, and so on. The intent is to bake a prepared and shaped layered dough in a thermal cycle oven, and then to dry the baked layered product with microwaves, radio waves, or infrared rays.

An edible laminated dough and edible lamination dispersion therefor is taught in van Eendenburg et al. U.S. Pat. No. 6,248,388, issued Jun. 19, 2001. Here, the laminated dough is made with a water continuous lamination dispersion where the lamination dispersion has 15% to 90% water content, and a fat content of 0 to 80%. A wide range of laminated baked products can be obtained having less or more nutritionally attractive fats and having different taste profiles. Cheese is mentioned as being a component in the lamination dispersion so as to make cheese croissants; or egg yolk may be used in other instances.

Lantz et al. were awarded U.S. Pat. No. 6,277,433 on Aug. 21, 2001 for randomized fats from triglycerides, some of which randomized fats can be used in margarine compositions particularly intended for puff pastry margarines or cream margarines. The fats or fat blends could also be used in the preparation of other shortenings, or even frying fats.

Huxel, U.S. Pat. No. 6,932,996, issued Aug. 23, 2005, teaches coated flaked fats, particularly solid flakes of fats and emulsifiers which have a solid content index, or SFI, which is below the agglomeration boundary, thus allowing the application of a coating to flakes so as to assist in avoiding loss of flake separation and to maintain pourability of the flaked product. The patent contemplates the use of a variety of edible oils such as cottonseed oil, soybean oil, corn oil, peanut oil, sunflower oil, castor seed oil, sunflower oil, palm and olive oils, and so on. It also mentions that the addition of various additives into the mixtures to be flaked may be provided for. However, such additives are will typically lower the melting point of the liquid composition. Such additives may be flavoring such as butter, butter milk, cinnamon, or colors. The patent states that the depression of the melting point which occurs when additives are included in the liquid is overcome.

Finally, the inventor herein is also the inventor in U.S. Pat. No. 6,984,408, which issued Jan. 10, 2006. The focus of that patent was to provide a pastry fat composition which comprised botanically derived unhydrogenated oil. That oil could be used, along with long chain unhydrogenated vegetable oil, hard wheat flour, liquid, and lecithin, in the preparation of a puff pastry having improved lift and flakiness. The teaching here is that the use of hydrogenated and/or partially hydrogenated fats and/or oils is precluded, so that the baked puff pastry product contains little or no saturated fats and/or trans-fatty acids. This provides a healthier puff pastry, but the same time is able to replicate the organoleptic properties of real butter or lard in a puff pastry product. The consumer will therefore obtain a pleasant mouth feel when eating a puff pastry made with the pastry fat composition which includes botanically derived unhydrogenated oils.

### SUMMARY OF THE INVENTION

In keeping with the present invention, there is provided a flavor infused pastry fat composition for the preparation of puff pastry baked products.

The flavoring agent is incorporated into the fat phase of the pastry fat during its preparation so as to become part of the fat phase of a puff pastry baked product, when baked.

Moreover, the flavor infused pastry fat preferably has an SFI characteristic such that it is liquid at 36° C., is solid at 4° C., and has 26% to 40% solid fat component at 10° C. and 10% to 30% solid fat component at 25° C.

The present invention provides that the flavoring agent may be chosen from the group consisting of butter, cocoa fat, cheese fat, coffee powder, spice, liqueur, liquor, fruit flavored fats having essentially the same SFI characteristic as the flavor infused pastry fat, and mixtures and combinations thereof.

A provision of the present invention is that the flavoring agent has been added to and thoroughly mixed into the pastry fat when in its liquid phase so as to enter into the fat phase thereof.

Also, the fat phase component thereof may be chosen from the group consisting of butter, margarine, vegetable shortening, lard, and mixtures and combinations thereof.

Another aspect of the present invention provides a method of making a puff pastry baked product comprising, at least as the major constituents of the dough thereof, flour, water, salt, together with a flavor infused pastry fat as described above.

Here, a sheet of the puff pastry dough is coated with the flavor infused pastry fat and is repeatedly folded and re-folded so as to preferably have from 7 to 730 layers, and more preferably 10 to 100 layers, of pastry dough interspersed with layers of said flavor infused pastry fat.

After each folding operation, the then folded pastry dough is rolled so as to reduce its thickness.

Typically, the preparation of the interspersed layers of pastry dough and flavor infused pastry fat is carried out at temperatures in the range of 10° C. to 25° C.

The present invention provides that, intermittently, after a predetermined number of folding and rolling operations, (or after each folding and rolling operation), the rolled pastry is preferably permitted to rest for a period of at least 5 minutes at a temperature in the range of 5° C. to 20° C.

Of course, as noted above, particularly in the case of Danish pastries, a further major constituent of the dough is yeast.

In yet another aspect, the present invention also provides a puff pastry made of the flavor infused pastry fat composition, as described above.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

As noted above, a principal object or purpose of the present invention is to provide flavored baked puff pastry products where the flavoring agent for the baked puff pastry product has been included in the formulation and production of the baked puff pastry product ab initio. Thus, there is no requirement for the use of discrete flavoring additives to be placed into or on the puff pastry product immediately prior to or just after the baking operation, or both. As discussed, and as will be explained hereafter, the simple expedient by which this goal is achieved is to employ flavor infused pastry fat. By that, of course, it is understood that the pastry fat is otherwise appropriate for the preparation of baked puff pastry products, including particularly its SFI characteristic as well as its plasticity and handling characteristics at typical room temperatures and below—but, of course, above freezing.

Typical pastry fats which are particularly applicable for use in the preparation of baked puff pastry products such as puff pastry shells, croissants, Danish pastries, and the like, are vegetable and/or animal derived fats such as butter, lard, margarine, vegetable shortening, and mixtures and combinations thereof. In general, it is desirable for the SFI characteristic of whatever pastry fat is employed for the production of baked puff pastry products to more or less emulate that of butter.

More particularly, it has been found to be advantageous in the practice of the present invention for the SFI characteristic of whatever pastry fat is employed to be preferably such that the fat is liquid at 36° C. and solid at 4° C. In the intervening temperature range, it is advantageous for the solid fat component at 10° C. to be in the range of 26% to 40%, and for the solid fat component at 25° C. to be in the range of 10% to 30%.

As stated, the flavoring agent by which the flavor is imparted to the baked puff pastry product is incorporated into the fat phase of the pastry fat during its preparation. Thus, when the puff pastry product is to be baked, the prepared pastry fat and the flavoring agent which has been incorporated therein are part of the fat phase, and are indistinguishable therefrom. This can be accomplished in several manners.

For example, the use of flavored fats, per se, is contemplated; providing that the flavored fats have an SFI characteristic within the limits defined above, or at least that the prepared flavor infused pastry fat composition exhibits that SFI characteristic after the flavored fat has been incorporated into the pastry fat. Typical examples of such fat systems per se include cocoa butter or cocoa fat, dairy butter, or cheese fat—typically that has been separated from the cheese during its preparation. Obviously, use of such fats as they are discussed immediately above will provide identifiable flavors to the baked puff pastry product, being chocolate, butter, or cheese flavors, respectively.

Other flavoring agents that may be incorporated into the pastry fat so as to be infused therein may include coffee powder, or finely ground spices or herbs—for example, cinnamon or dill or mint. In that case, the flavoring agent is incorporated into the pastry fat at a temperature above the full melting point of the fat system being employed, so that the flavoring agent may be thoroughly mixed into the liquid fat system at an elevated temperature. Thereafter, the liquid fat system having the flavoring agent incorporated therein is cooled in an appropriate, scraped surface heat exchanger, such as a well known Votator (™) machine. The recovered, cooled pastry fat is therefore flavor infused but otherwise exhibits the same SFI characteristic and handling characteristics as an ordinary, commonly used pastry fat.

Still other flavoring agents may be incorporated into the pastry fat so as to be infused therein. They include various liqueurs and liquors, which are liquids and which may be incorporated into the fat phase of the pastry fat at an elevated temperature when the pastry fat is in its liquid phase.

Some fruit flavored fats are available in the market, where a fruit essence has been incorporated into the fat. Such fats typically are very hard, so that suitable adjustments must be made if they are to be employed in a pastry fat in keeping with the present invention in order to derive the required SFI characteristic. If so, then the fruit flavor will be imparted to the baked puff pastry product.

Of course, it must be stressed that the initial fat phase of the pastry fat to be employed in keeping with the present invention may be derived from butter, lard, margarine, vegetable shortening, or mixtures or combinations thereof. The preparation of the initial pastry fat to be employed, or the choice of that initial pastry fat, will take into regard either the lack of any flavor contribution to the baked puff pastry product or such flavor contribution as a buttery flavor, when consideration of the type and amount of flavoring agent to be infused into the fat phase of the initial pastry fat is made. In any event, it is evident that the flavoring agent is added to and thoroughly mixed into the pastry fat when it is in its liquid phase so that, upon cooling and recovery of the pastry fat, the flavoring agent has entered into the fat phase.

It is beyond the scope of the present invention to provide specific methods and criteria either for the preparation of the flavor infused pastry fat composition, or for the preparation of a baked puff pastry product. However, it is within the purpose and intention of the present invention to provide a general method for making baked puff pastry products because, as is well known to those skilled in the puff pastry art, the initial puff pastry product just prior to its baking must comprise a plurality of layers of pastry dough interspersed with layers of pastry fat. However, in the case of the present invention, the pastry fat has been flavor infused, so that a flavor is imparted to the puff pastry product when it has been baked. Thus, the present invention contemplates that there is no necessity for any additional step following the baking operation, such as placing a flavored icing on the product; neither is there any necessity for the placement of a discrete flavoring agent on the unbaked folded and rolled puff pastry dough just prior to the final folding and/or shaping of the puff pastry product to be baked.

Indeed, it is been noted that a typical puff pastry product in keeping with the present invention, having a flavor infused pastry fat constituent, will typically comprise from 7 to 730 layers of pastry dough interspersed with layers of the flavor infused pastry fat. The number of folding operations (and indeed the folding method per se, such as Blitz or Scottish, English, or French methods) are within the skill of a puff pastry baker, having regard to the nature of the baked puff pastry product to be made—for example, puff pastry shells, croissants, or Danish pastries.

In any event, a typical baked puff pastry product will comprise, at least as the major constituents of the dough thereof, flour, water, and salt; and in the case of Danish pastries, a small amount of yeast as well. In any event, a typical baked puff pastry product in keeping with the present invention is a flavored baked puff pastry product, and incorporates a flavor infused pastry fat in keeping with the present invention, and as discussed above. Upon consumption of a baked puff pastry product in keeping with the present invention, a discernable flavor will be noted, along with the expected pleasant mouth feel of such a baked puff pastry product.

Thus, in keeping with the invention, baked puff pastry products which incorporate a flavor infused pastry fat are prepared by the usual steps of coating a sheet of puff pastry dough with the flavor infused pastry fat and repeatedly folding and refolding the dough/pastry fat preparation, and rolling the then folded pastry dough following each folding operation.

Typically, and of course for the production of the most favorably acceptable baked puff pastry products, the preparation of the interspersed layers of pastry dough and flavor infused pastry fat—in other words, the folding operation followed by the rolling operation—is preferably carried out at temperatures in the range of 10° C. to 25° C. It is also known that such products are typically proofed or subjected to a retarder step at a reduced temperature, typically in the range of 5° C. to 20° C. Typically, proofing may occur after each folding and rolling step, or after a predetermined number of folding and rolling steps.

In carrying out the present invention, care must be taken that the flavor infused pastry fat is neither too soft nor too hard, so as neither to soak right into the dough or to tear the dough. Of course, this is accomplished by assuring that the SFI characteristic is as described above, namely that the flavor infused pastry fat is liquid at 36° C., is solid at 4° C., has 26% to 40% solid fat component at 10° C., and has 10% to 30% solid fat component at 25° C.

Also, it should be clear that the present invention does not preclude the addition of other flavoring additives including chocolate, raspberry, and the like, or fruit and pie fillings, or the like, to the flavor infused rolled dough, or pastry fat sheet, prior to baking.

While specific examples and various features and components of the present invention have been discussed herein, it will be apparent to those skilled in the art that desired subsets of the disclosed features and components, and/or alternative combinations of those features and components, can be utilized as desired and without departing from the spirit or scope of the appended claims.

Throughout this specification and the claims which follow, unless the context requires otherwise, the word “comprise” and variations thereof such as “comprises” or “comprising”, will be understood to imply the inclusion of a stated integer or step or group of integers or steps but not to the exclusion of any other integer or step or group of integers or steps.

Moreover, words such as “substantially” or “essentially”,—particularly when used with an adjective or adverb—is intended to enhance the scope of the particular characteristic; e.g., substantially planar is intended to mean planar, nearly planar and/or exhibiting characteristics associated with a planar element.

Also, while this discussion has addressed prior art known to the inventor, it is not an admission that all art discussed is citable against the present application.

I claim:

1. A flavor infused pastry fat composition for the preparation of puff pastry baked products;
wherein a flavoring agent is incorporated into the fat phase of the pastry fat during its preparation so as to become part of the fat phase of a puff pastry baked product, when baked; and
wherein the flavor infused pastry fat has an SFI characteristic such that it is liquid at 36° C., is solid at 4° C., and has 26% to 40% solid fat component at 10° C. and 10% to 30% solid fat component at 25° C.

2. The flavor infused pastry fat composition of claim 1, wherein the flavoring agent is chosen from the group consisting of butter, cocoa fat, cheese fat, coffee powder, spice, liqueur, liquor, fruit flavored fats having essentially the same SFI characteristic as the flavor infused pastry fat, and mixtures and combinations thereof.

3. The flavor infused pastry fat composition of claim 1, wherein the flavoring agent has been added to and thoroughly mixed into the pastry fat when in its liquid phase so as to enter into the fat phase thereof.

4. The flavor infused pastry fat composition of claim 1, wherein the fat phase component thereof is chosen from the group consisting of butter, margarine, vegetable shortening, lard, and mixtures and combinations thereof.

5. A method of making a baked puff pastry product comprising, at least as the major constituents of the dough thereof, flour, water, and salt, together with a flavor infused pastry fat as claimed in claim 1;
wherein a sheet of the puff pastry dough is coated with said flavor infused pastry fat and is repeatedly folded and re-folded so as to have from 7 to 730 layers of pastry dough interspersed with layers of said flavor infused pastry fat; and
wherein, after each folding operation, the then folded pastry dough is rolled so as to reduce its thickness.

6. The method of claim 5, wherein the preparation of the interspersed layers of pastry dough and flavor infused pastry fat is carried out at temperatures in the range of 10° C. to 25° C.

7. The method of claim 5, wherein intermittently, after a predetermined number of folding and rolling operations, the rolled pastry is permitted to rest for a period of at least 5 minutes at a temperature in the range of 5° C. to 20° C.

8. The method of claim 5, wherein the major constituents of the dough further include yeast.

9. A puff pastry comprising a flavor infused pastry fat composition as claimed in claim 1.
